(19) United States
(12) Patent Application Publication
(10) Pub. No.: US 2007/0083930 A1
(43) Pub. Date: Apr. 12, 2007

(54) Method, telecommunications node, and computer data signal message for optimizing virus scanning

(76) Inventors: Jim Dumont, Dollard des Ormeaux (CA); Robin Joseph, Kirkland (CA)

Correspondence Address: Alex Nicolaescu;Ericsson Canada Inc., Patent Department, 8400 Decarie Blvd., Town Mount Royal, QC, H4P 2N2, CA

(21) Appl. No.: 11/246,155

(22) Filed: Oct. 11, 2005

(51) Int. Cl. G06F 12/14

(52) U.S. Cl. 726/24

(57) ABSTRACT

A method, telecommunications node and computer data signal message are provided for optimising the virus scan process in a network with multiple nodes. When a node scans a message for viruses, it also includes in the message a virus scan tag indicating that the message was scanned and is virus-free. Optionally, the virus scan tag includes a virus scan application Id and a virus definition file Id of the application and virus definition file used for the scan. Also optionally, the message comprises security information, such as an electronic signature, encryption, integrity check information, or the sender's node Id. The receiving side may analyse the security information from the message, and if the content is determined to be trusted, may further check the virus scan tag to determine if the message was already scanned for viruses. If so, the receiving side may skip scanning the message again for viruses.

### BACKGROUND OF THE INVENTION

1. Field of the Invention

The present invention relates to a method and system for optimizing the process of virus scan in a telecommunications network with multiple nodes.

1. Description of the Related Art

Many telecommunication networks and computers use virus scan applications for scanning incoming and outgoing messages for viruses. Such networks include corporate and universities' Local Area Networks (LANs) and Wide Area Networks (WANs), where for example email messages are scanned by email servers for finding and eliminating any viruses found therein. Electronic viruses (herein after also called simply “viruses”) are not only a threat to email servers and terminals. With the emergence of new types of telecommunications networks, viruses can now spread using Multimedia Messaging System (MMS) networks (typically via cellular networks), Instant Messaging (IM), IP Multimedia System (IMS) based networks etc. Servers and user terminals of each one of these networks are at risk of being infected and severed by an electronic virus.

In order to cope with this threat, each one of these networks implement virus scan protection at various levels. Telecommunication servers such email or MMS servers typically scan all incoming messages for virus location and elimination and, in certain implementations, outgoing messages are scanned as well.

For example, email servers scan each email message received from another server to locate and destroy electronic viruses that may be contained therein, and only after the virus scan process does the email server relay the email messages to the destination user terminals. The process is performed despite the fact that certain incoming email messages have already been scanned for virus location and destruction by the outgoing email server that sent them. In such instances, the new virus scan process provides no added protection while wasting processing resources at the receiving email server.

Reference is now made to FIG. 1 (Prior Art), which is a high-level representation of a telecommunication network 100 where virus scan processes are unduly duplicated thus wasting processing resources of various nodes. Shown in FIG. 1, is a telecommunications network 100 that comprises the Internet 102, a LAN 104, a WAN 106, and an Internet Service Provider (ISP) network 108. The LAN 104 may be a corporate LAN, which comprises an email server 123, and multiple client terminals 112, that may be LAN-connected Personal Computers (PCs). The ISP network 108 also comprises a server 125, which may be an Internet server/email server, and further comprises multiple client terminals 114 that may be home PCs of the ISP subscribers. The WAN 106 may be another corporate WAN, which comprises an email server 127 that serves client terminals 116, which again may be corporate PCs. When a user of one of the client terminals 112 of the network 104 creates a new email message 121 destined both to a first subscriber of the ISP network 108 and to second subscriber of the WAN 106, the message 121 is first scanned by the outgoing email server 123 for locating and destroying any viruses that could be found therein, action 120. Then the scanned message 121′ is sent toward its destination, action 122, and transits via the Internet 102 to reach its destination networks 108 and 106. Upon receipt of the message 121′, the server 125 of the ISP network 108 which is also configured to scan all incoming messages, also acts to scan the already scanned message 121′ for locating and destroying any viruses, action 120′, and then sends in action 124 the twice-scanned message 121″ to its destination, which in the present case is assumed to be one of the client terminals 114. The later terminal may also have installed a virus scan application program, so it may also act to scan the twice-scanned incoming message 121″, in order to locate and destroy any possible viruses.

Similarly, the server 127 of the WAN network 106 also receives the scanned message 121′ and, because it may also be configured to scan all incoming messages, in action 120′″ also acts to scan the message for finding and destroying any possible viruses. Then only, in action 130, it acts to send the twice scanned message 121′″ to its final destination, which in the present case is assumed to be one of the client terminal 116. The latter, having also installed a virus can application program, also acts to scan the incoming message for locating and is destroying any possible viruses, action 120″″.

In the prior art implementation described with reference to FIG. 1, the same message is a scanned for viruses three times along a path from the sender to one of the intended recipients. Hence, processing resources are unduly wasted for performing virus scan operations that do not add any increased protection. Even if certain ones of the networks through which the message transits are considered insecure, such as for example the Internet 102, and servers 125 and 108 are reasonably configured to scan for viruses every incoming message that transited over the insecure network because of the risk of modification of the message during this transit, the client terminals 114 and 116 still waste their processing resources by duplicating the virus scan process, because their respective networks 108 and 106 are considered to be secured networks and virus scan processes were already performed by servers 125 and 127 respectively.

Reference is now made to FIG. 2 (Prior Art), which is a high-level representation of an existing MMS network 200 where virus scan processes are also unduly duplicated. The MMS network 200 comprises a plurality of MMS client terminals 202 and a central Multimedia Messaging Center (MMC) 208 through which transit all MMS messages of the network 200. Connected to the MMC 208 are an MMP 210 (MulitMedia Processor), which function is to adapt multimedia content (pictures, video, audio) to sizes/formats optimized for the receiving device, a Multimedia Messaging Library (MML) 212, which functions to store MMS messages on behalf of MMS subscribers as well as providing functions to share and compose MMS messages, another, secondary MMC 214, which may function to support another operator's network, and a Wireless Application Protocol (WAP) gateway 216 responsible for delivering the MMS message to the receiver. When an MMS subscriber creates and issues a new MMS message 206 using his client terminal 202, the MMS message may be scanned for viruses by the client terminal itself (if so configured) and then sent to the MMC 208. The later may also be configured to scan for viruses every incoming MMS message, so in action 203 it also acts to scan for locating and destroying any viruses from the incoming message 206. Then only the MMC 208 transmits the scanned message 206′ toward its intended destination, which in the present case is assumed to be the MML 212. The later receives the message 206′, and being configured to do so, acts again to scan the message 206′ for viruses, action 203′.

Conclusively, virus scan processes are unduly duplicated in many types of networks, thus wasting processing resources of many network operators' nodes. Such duplications result in slower traffic and increased network maintenance costs for the network operators.

Although there is no prior art solution as the one proposed hereinafter by the present invention for solving the above-mentioned deficiencies, the U.S. patent publication US-2003120950 by KONINK PHILIPS ELECTRONICS NV bears some relation with the field of the present invention. In this publication, there is disclosed a method which involves analysing an e-mail message for viruses using an anti-virus Service Provider (SP). A virus of an infected computer self propagates and uses the local address book of an infected computer to send the e-mails containing the virus to other computers. An automated service generates an e-mail reply containing a notification of the suspected presence of virus either to the virus-infected computer or to other computers. Using this notification, the file including the virus may be found and disinfected, and executable code can even be transmitted to an infected computer for cleaning purposes.

The Great-Britain patent GB-2364142 issued to MORRIS R also bears some relation with the field of the present invention. In this patent, a system comprises a computer program, which triggers on receiving an e-mail virus, sends an e-mail message to the user to inform of the presence of the virus, stops e-mail messages queued for delivery and alerts the system administrator to remove the virus.

Finally, in some implementation, email service providers, such as for example America OnLine (AoL), offer email protection against viruses. All email messages that transit through the AoL email server are first scanned for viruses. When a message is suspected of being infected, the message is cleaned up, and a notification can also be inserted in the body of the email message. In other circumstances, the infected file may be quarantined in a specific folder, which the user may access after being warned of the suspected infection.

None of the above-mentioned pieces of the existing state-of-the-art methods for virus scan offer an end-to-end optimized solution for scanning messages.

Accordingly, it should be readily appreciated that in order to overcome the deficiencies and shortcomings of the existing solutions, it would be advantageous to have a method and system for effectively scanning messages in order to locate and destroy possible viruses, while also optimizing the processing resources dedicated to this task. The present invention provides such a method and system.

### SUMMARY OF THE INVENTION

In one aspect, the present invention is a method for avoiding duplication of virus scan processes, the method comprising the steps of:

a. receiving a message at a communications node, the message comprising a virus scan tag which indicates whether or not the message was already scanned for electronic viruses;

b. analysing the virus scan tag of the message, to determine whether or not the message was already scanned for electronic viruses;

c. responsive to a determination that the message was already scanned for viruses, processing the message without scanning the message again for finding viruses.

In another aspect, the present invention is a communications node comprising:

a communication interface receiving a message that comprises a virus scan tag which indicates whether or not the message was already scanned for electronic viruses;

a virus scan tag interpreter analysing the virus scan tag of the message to determine whether or not the message was already scanned for electronic viruses;

a processor that responsive to a determination by the virus scan tag interpreter that the message was already scanned for electronic viruses, processes the message without scanning the message again for finding viruses.

In yet another aspect, the present invention is a computer data signal message embodied in a transmission medium, the message comprising:

a virus scan tag segment which indicates whether or not the message was already scanned for electronic viruses; and

a security information segment for use by a receiving node of the message to authenticate the message;

wherein the receiving node uses the virus scan tag and the security information to determine whether or not the message is to be scanned for viruses.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is high level representation of a telecommunication network where virus scan processes are unduly duplicated;

FIG. 2 (Prior Art) is a high-level representation of a Multimedia System (MMS) network where virus scan processes are also unduly duplicated;

FIG. 3 is a nodal operation and signal flow diagram of an exemplary telecommunications network implementing the preferred embodiment of the present invention;

FIG. 4 is a high-level block diagram of an exemplary telecommunication node implementing the preferred embodiment of the present invention; and

FIG. 5 is a high-level representation of an exemplary message structure used in conjunction with the preferred embodiment of the present invention.

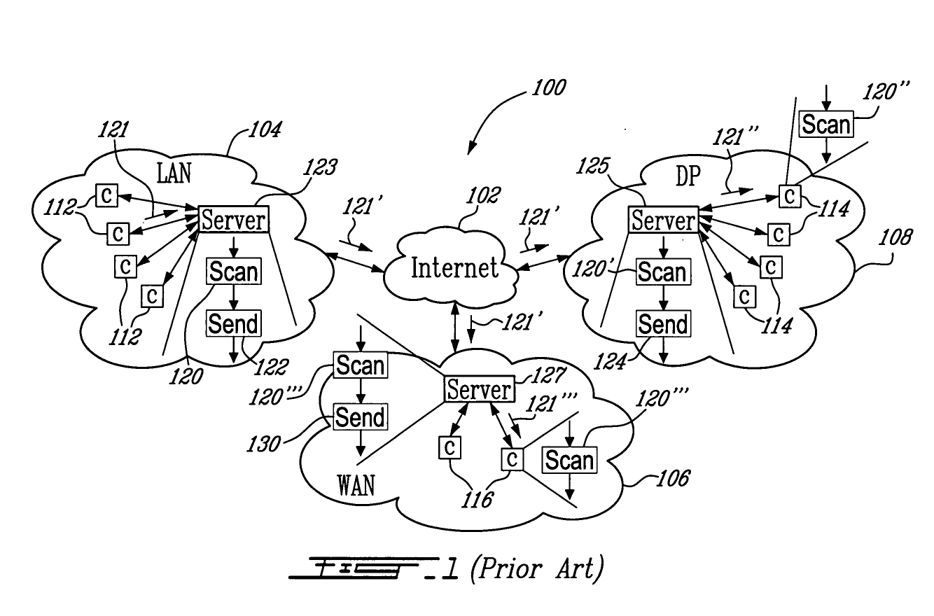

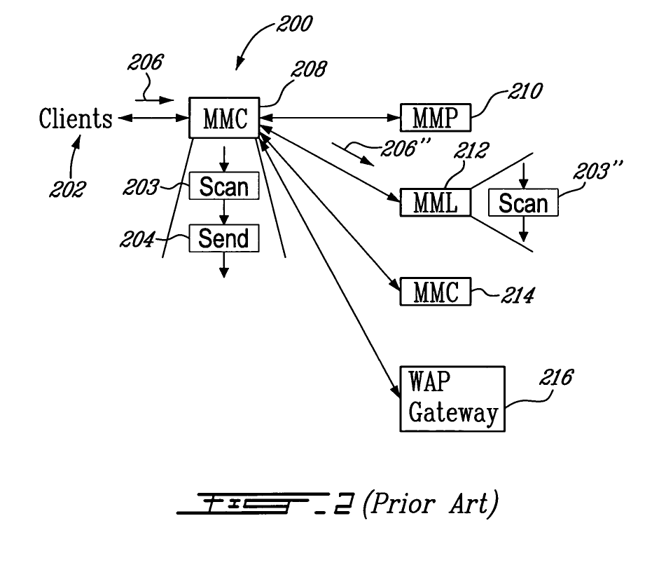

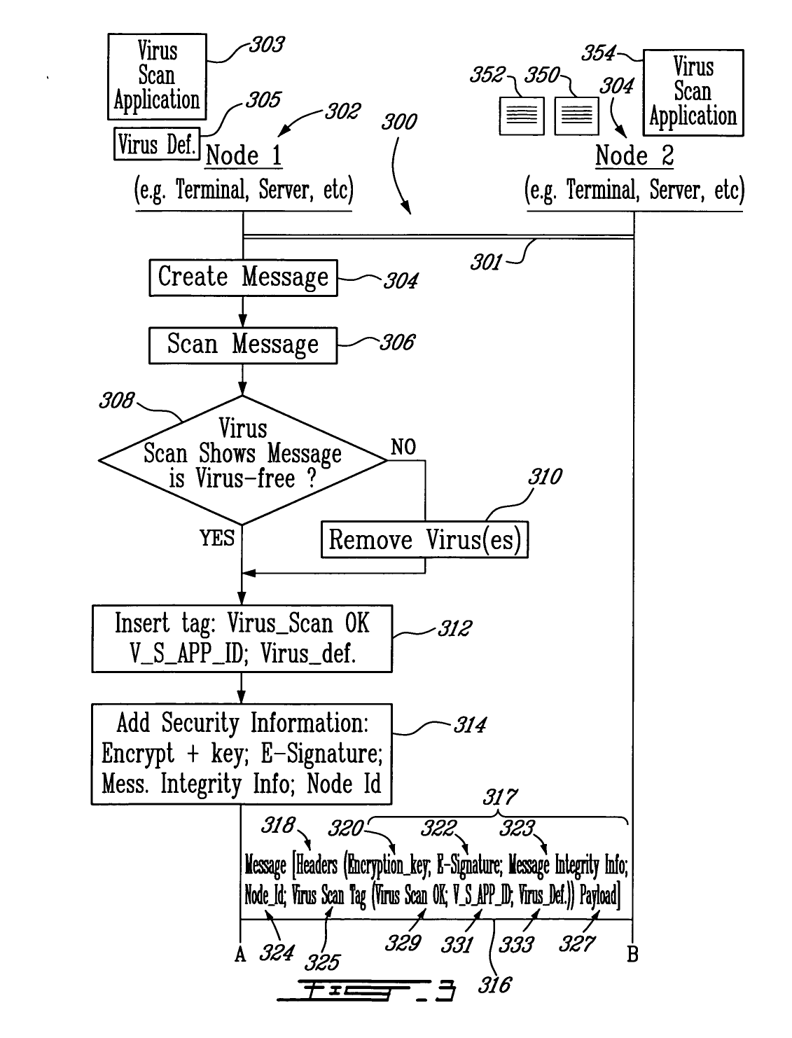

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention optimizes the virus scan process in various types of telecommunications networks by eliminating any undue duplication of virus scanning. Accordingly, the present invention allows for a meaningful virus scan to be performed on a given message and for the elimination of undue virus scanning of the same message. In accordance to the present invention, when the given message has already been scanned for viruses, an indication is added to each message that is exchanged in a network. According to the invention, when a telecommunications node sends a new message, it adds first, a tag indicating if the message has already been scanned for viruses, and second, an optional message protection information that may be in the form of an electronic message encryption, electronic signature, message integrity information or originating node identity. Upon receipt of the message, a receiving node analyses the content of the message, and retrieves the tag, which indicates that the message has already been scanned for viruses. The destination node may thus skip performing yet another virus scan for the message. In a variant of the invention, the destination node may also analyse the optional message protection information to authenticate the message and/or the sending node. Only in the case wherein the authentication is successful, i.e. the destination node trusts the message and/or the sending node capabilities for virus scan, and that the tag indicates a previous virus scan has actually been performed for that message, the destination node skips performing the new virus scan.

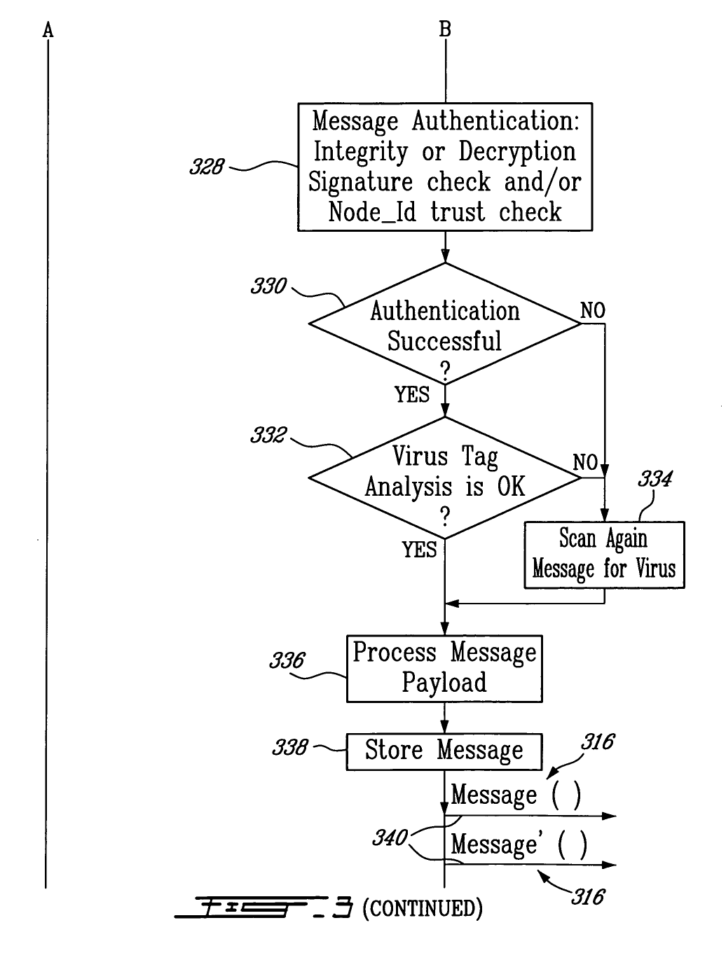

Reference is now made to FIG. 3, which is a nodal operation and signal flow diagram of an exemplary telecommunications network 300 implementing the preferred embodiment of the present invention. Shown in FIG. 3 is a network 300 that may be any kind of telecommunications network, such as for example the Internet, a LAN (Local Area Network), a WAN (Wide Area Network), a WLAN (Wireless Local Area Network), a cellular network, a messaging network or the like. The network 300 comprises a first node 302 and a second node 304, which may be servers of various kinds, a client and a server, or any other type of communications nodes, including but being not limited to a packet-switched node, a messaging sever alike an email server, an SMS (Short Messaging Service) server, an MMS (Multimedia Messaging Service), an IMS (IP Multimedia Subsystem) message or any other type of servers or terminals (e.g. PC, mobile terminal, etc). The nodes 302 and 304 may be connected via an appropriate transmission medium 301, such as an electronic communications interface which may be of various types, such as for example fiber optics, twisted pair copper cables, co-axial cable or the like that supports circuit-switched or packet-switched communications using various appropriate communications protocol.

Examples of such protocols can be the Simple Mail Transfer Protocol (SMTP), the Global System for Mobile Communications (GSM), the Code Division Multiple Access (CDMA2000), the Universal Mobile Telephone System (UMTS), the Session Initiation Protocol (SIP), or other IP-based protocols.

For the sake of better understanding the present invention, it is assumed in the exemplary scenario described in relation to FIG. 3 that the first node 302 sends a message to the second node 304. This message may be of various types. An example of such a message may be when the first node 302 is an MMS terminal, the second node is an MMC, and the message is an MMS message. In action 304, the message is created at the first node 302. For example, a user using the node 302 as an MMS terminal may create the MMS message by opening an MMS application installed on the terminal, select or type an address of destination for the message, and add or create a message content. Once the message is created, in action 306, the newly created message is scanned for viruses by the node 302, such as for example by using a virus scan application 303 that uses a certain virus definition file 305, as it is known in the art. In action 308, there is determined if the virus scan process of action 306 found any viruses therein. If so, in action 310, the virus scan application 303 may remove the located virus(es) from the message. Thereafter, or if the operation 308 found no viruses in the message, in action 312 the node 302 adds to the scanned message a virus scan tag indicating that the message has been successfully scanned for viruses, and that the message contains no known viruses. Optionally, in a variant of the invention which is yet to be described in detail, the virus scan tag 325 may contain an identification of the virus scan application 303 and/or an identification of the virus definition 305 used for the virus scan process described in actions 306-308.

As a further option, the node 302 may also include in the message optional message protection information, also called herein security information, for protecting the authenticity of the message, action 314. Such security information may include an electronic signature of the message, an encryption key associated with the encryption of portions of the message or of the entire message, message integrity information (e.g. a bit checksum), the identity of the sending node (node 302), or any other type of security information that may be utilized by the receiving node (node 304) in order to authenticate the message or the sending node in order to ascertain that the information of the message is legitimate.

In action 316, the message with the virus scan tag 325 and possibly the security information 317 is sent from node 302 to node 304. According to the invention, the virus scan tag 325 and the optional security information 317 may be included in one or more of the message's headers 318. The security information 317 of the message 316 may include an encryption key 320 for decrypting the message 316 or portions thereof, an electronic signature 322 for authenticating the legitimate origin message, message integrity information 323 that may be, for example, in the form of a bit checksum for all the message's bits, and a node identity 324 of the sending node 302 for identifying the node that sent the message. The virus scan tag 325 may contain a virus scan ok indication 329 showing that the message 316 is virus-free, an identification 331 of the virus scan application and an identification 333 of the virus definition used for the virus scan process of actions 306-308.

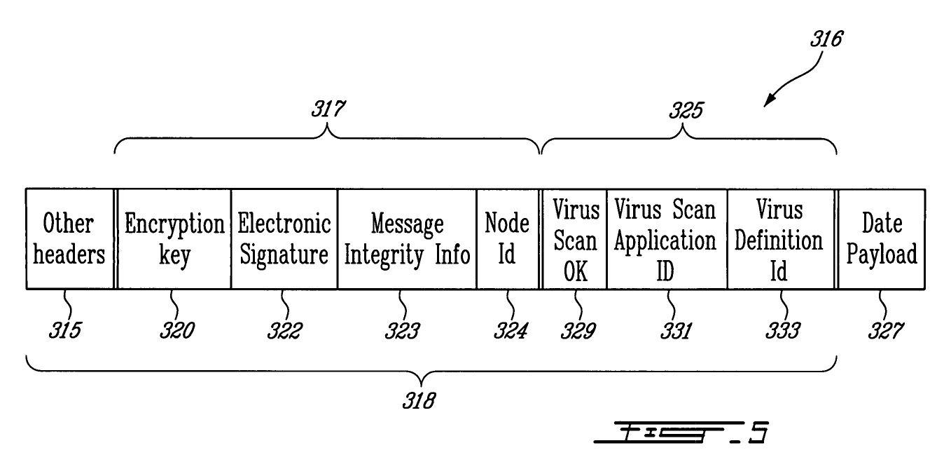

Reference is now briefly made to FIG. 5, which is a high-level representation of an exemplary message structure used in conjunction with the preferred embodiment of the present invention. The message 316 may be a computer data signal message of various types embodied in a transmission medium for transport between a first node like the node 302 and a second node like the node 304. The computer data signal message may comprise various headers 318 and a data payload segment 327, which carries the message content. The headers 318 may have a portion 315 that contains various kinds of information, such as for example the message sender's address, the message destination address, transmission protocol information, etc. Other headers may contain information that may be used by the present invention. Included in one or more of such headers may be the virus scan tag segment 325, which indicates that the message 316 has been scanned for viruses and that it is virus-free. The tag 325 may comprise a virus scan ok indication segment 329 that indicates the clean state of the message (the message is virus-free), a virus scan application identifier segment 331 that identifies the application used for the scan, and a virus definition file identifier segment 333 that identifies the virus scan definition file used for the scan. Also included in one or more headers is the security information segment 317, which may contain an encryption key segment 320, an electronic signature segment 322, message integrity information 323, and a node identifier segment 324.

With reference being now made back to FIG. 3, upon receipt of the message 316 at the second node 304, if the implementation is of the type wherein the message 316 also contains the optional security information 317, the node 304 may first act to analyze the security information 317 of the message 316, action 328. In such an implementation, the node 304 may, for example, start by authenticating the message 316. For this purpose, the node 304 may use the electronic signature 322 for determining if the message is legitimate, and/or to decrypt the message 316 using the encryption key 320, and/orto determine the message integrity using the message integrity information 323, and/or to identify the sending node using the node identifier 324. Based on the security information 317, in action 330, the second node 304 determines whether or not the message is successfully authenticated, i.e. whether or not the content of the message 316 may be trusted or not. Such action may comprise the comparison of the node identifier 324 retrieved from message 316 with a list 350 of nodes trusted by the node 304, and/or the determination of whether the authentication of the message 316 was successful based on the signature 322, and/or the successful decryption of the message, and/or the determination that the integrity of the message 316 is satisfactory. Such conclusion may be taken as a result of a combination of any of these actions, depending of the particular implementation. If the authentication is not successful, i.e. if the message 316 was not successfully authenticated, such as for example if the electronic signature was not properly recognized, or if the identity of the sending node indicates an un-trusted node, then the node 304 concludes that the content of the message 316 cannot be trusted, and the message is scanned again for viruses using a virus scan application 354 installed on the node 304, action 334. Otherwise, if the authentication of action 328 is successful, then the node 304 further acts to analyze the virus scan tag 325 to determine whether or not the message 316 was already scanned for viruses and if it is indicated to be virus-free. The verification of action 332 may be performed in various ways, depending upon the implementation. For example, the node 304 may determine only if the message was already scanned for viruses based on the virus scan ok information 329, or may further determine if the application and virus definition file used for the virus scan of action 306 are appropriate and trusted, by further analyzing the indications 331 and 333, and comparing them with a list 352 of trusted virus scan applications and virus file definitions. If the conclusion of the determination 332 is negative, i.e. the node 304 finds out that the virus scan indication 329 does not indicate a virus-free message, or the indications 331 or 333 indicate an un-trusted virus scan application or virus definition file, the node 304 acts to scan again the message 316 for finding and destroying any possible viruses, action 334. Otherwise, if the node 304 finds out in action 332 that the message 316 has been already scanned and is virus-free, or that besides the message being virus-free, the application and virus definition file used for the virus scan are trusted by node 304, then the virus scan process of action 334 is skipped, and the node 304 continues to process the message 316, action 336. Such processing may take various forms depending upon the nature of the node 304 and the one of the message 316. For example, in the case of the exemplary MMS message, the processing may comprise the storage of the MMS message 316, action 338, or the forwarding of the message 316 to other nodes of the network (not shown), actions 340.

The invention as described hereinbefore may be implemented in a plurality of cooperating telecommunication nodes, alike the nodes 302 and 304 described herein. In such implementations, when a given message transits via multiple successive nodes, once one of the nodes scans the message for viruses, it inserts the virus scan tag and optionally the security information into the message, so that the nodes that subsequently receive the message are notified that the message has already been scanned for viruses, thus permitting the elimination of undue subsequent virus scan processes.

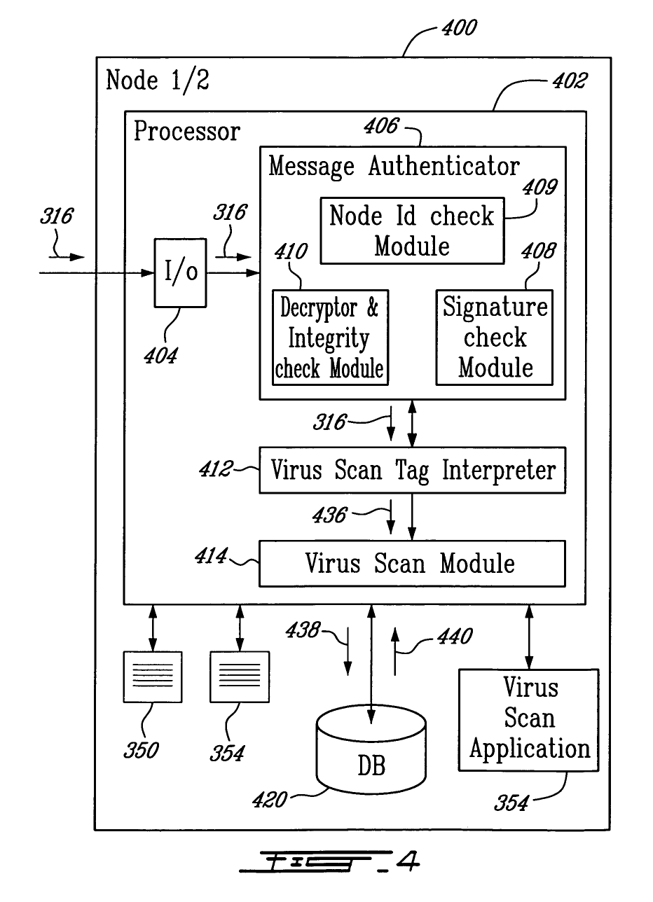

Reference is now made to FIG. 4, which is a high-level block diagram of an exemplary telecommunication node implementing the preferred embodiment of the present invention. Shown in FIG. 4 is a telecommunication node 400, alike the nodes 302 and 304, previously described, which implements the preferred embodiment of the present invention. The node 400 has a processor 402, which may comprise, first, a message authenticator module 406 responsible for analyzing the security information 317 from incoming messages alike the message 316. The processor 402 further comprises a virus scan tag interpreter 412 responsible for analyzing the virus scan tag 325 from incoming messages alike the message 316. Finally, the processor 402 further comprises a virus scan module responsible for scanning the incoming messages for finding and destroying any possible viruses. For this purpose, the processor 402 is connected to a virus can application 354 that is stored on the node 400 and uploaded for used by the processor 402. The node 400 may also comprise a database 420 for storing incoming messages, a list 352 of trusted virus scan applications and file definitions, and a list 350 of other cooperating nodes that are trusted by the node 400.

When an incoming message 316 (as previously described with reference to FIGS. 3 and 5) reaches the node 400, the message may be received by an input/output communication interface 404, which may be part of the processor 402 (as shown in FIG. 4 or not. The message 316 is then relayed to the message authenticator module 406, which acts to authenticate the message, i.e. to determine if the message content can be trusted or not. For this purpose, as mentioned hereinbefore with reference to FIG. 3, various actions can be performed depending upon the particular implementation. The message authenticator 406 may comprise a signature check module 408, which may verify the electronic signature 322 of the incoming message 316. The message authenticator 406 may also comprise a node Id check module 409 that may act to compare the identity of the sending node that is retrieved from the incoming message 316 with the list 350 of the other cooperating nodes that are trusted by the node 400, in order to determine whether or not the sending node is a trusted node. Finally, the message authenticator 406 may comprise a decryptor/intregrity check module 410 that may act to decrypt the incoming message 316 using the encryption key 320 and/or to check the integrity of the message 316 using the message integrity information 323. When the message authenticator 406 determines that the message content can be trusted, like in action 328-330 of FIG. 3, the message 316 is further sent to the virus scan tag interpreter 412, which further acts to determine if the message has already been scanned for viruses and if it is virus-free. For this purpose, the interpreter 412 analyses the virus scan tag 325.

Depending upon the implementation, the interpreter 412 may take into consideration one or more of the components of the virus scan tag 325, i.e. the virus scan ok information 329, the virus scan application identifier 331 and the virus definition file identifier 333, and based on this information, to determine if the message should, or should not be scanned again for viruses.

For example, the interpreter 412 may find that the virus scan ok information 329 states that the message has been already scanned for viruses and is virus-free, that the application 331 used for the scan and the virus definition file 333 are part of the list 352 of trusted applications, in which case the new scan process may be skipped (action 334 of FIG. 3 is skipped).

In another example, the interpreter 412 may find that the virus scan ok information 329 states that the message has been already scanned for viruses and is virus free, that the application used for the scan is part of the list 352 of trusted applications, but that the virus definition file identifier 333 is not part of the list 352. In such a circumstance, the virus scan tag interpreter 412 may conclude that the virus definition file used for the message scanning is outdated, and thus un-trusted, in which case it may relay the message 316 to the virus scan module 414 so that a new scan process may be performed on the message, action 334.

Similarly, action 334 may be performed as a result of an unsuccessful authentication for the message by the message authenticator 406, as determined in actions 328-330, in which case the message 316 may be relayed to the virus scan module 414 for scanning even without the interpreter analyzing the virus scan tag 325.

Following actions 332 and 334, the processor 402 may continue to process the message 316, as mentioned in relation to actions 336-340 of FIG. 3, by storing the message in the local database 420 or by forwarding the message 316 to other nodes, action 340.

Therefore, with the present invention it becomes possible to avoid the undue duplication of virus scanning of the same message. According to the invention, when a message is already scanned and is found to be virus-free, the nodes that receive the message may avoid such duplicate scanning by analysing the virus scan tag contained in the message, and optionally security information associated with the message to first authenticate the message.

The actions described in relation to FIG. 3 may be performed by various software modules, hardware modules, or any type of combination thereof of the nodes 302 and 304. For example, in a variant of the preferred embodiment of the invention, the processor 402, the modules 408, 409 and 410, as well as 412 and 414 may be software application programs and the node 400 may be a computer-based telecommunications node. In another variant of the preferred embodiment of the invention, the processor 402 and the modules 408, 409, and 410 may be at least in part implemented using hardware modules.

Based upon the foregoing, it should now be apparent to those of ordinary skills in the art that the present invention provides an advantageous solution, which avoids duplication of the scanning process on a given message that transits via plural telecommunications nodes. It should be realized upon reference hereto that the innovative teachings contained herein are not necessarily limited to a given type of message, but is rather applicable to various types of messages, including but being not limited to email messages, SMS/MMS messages, instant messages, etc. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for avoiding duplication of virus scan processes, the method comprising the steps of:
a. receiving a message at a communications node, the message comprising a virus scan tag which indicates whether or not the message was already scanned for electronic viruses;
b. analysing the virus scan tag of the message, to determine whether or not the message was already scanned for electronic viruses;
c. responsive to a determination that the message was already scanned for viruses, processing the message without scanning the message again for finding viruses.

2. The method claimed in claim 1, further comprises the steps of:
d. authenticating the message at the communications node prior to step c.;
wherein step c. is performed not only responsive to i) a determination that the message was already scanned for viruses, but also responsive to ii) a successful authentication of the message.

3. The method claimed in claim 2, wherein step d. comprises the step of:
d.1. verifying an electronic signature of the message at the communications node.

4. The method claimed in claim 2, wherein step d. comprises the step of:
d.1. verifying an identity of a sending node of the message at the communications node.

5. The method claimed in claim 2, wherein step d. comprises the step of:
d.1. decrypting the message at the communications node.

6. The method claimed in claim 2, wherein step d. comprises the step of:
d.1. verifying an integrity of the message at the communications node.

7. The method claimed in claim 2, wherein step d. comprises the step of:
d.1. checking the integrity of the message at the communications node.

8. The method claimed in claim 1, wherein the virus scan tag comprises a virus scan ok indication that indicates the message was already scanned for viruses, and a virus scan application identifier for identifying the application used for scanning the message, and wherein the method further comprises the steps of:
d. determining if the application used for scanning the message is trusted by the communications node;
wherein step c. is performed as a result of i) the determination that the message was already scanned for viruses, and ii) the application used for the scanning the message is trusted by the communications node.

9. The method claimed in claim 1, wherein the virus scan tag comprises a virus scan ok indication that indicates the message was already scanned for viruses, and a virus file definition identifier for identifying the virus definition file used for scanning the message, and wherein the method further comprises the steps of:
d. determining if the virus definition file used for the scanning the message is trusted by the communications node;
wherein step c. is performed as a result of i) the determination that the message was already scanned for viruses, and ii) the virus definition file used for the scanning the message is trusted by the communications node.

10. The method claimed in claim 1, the method further comprising the steps of:
d. responsive to a determination that the message was not scanned for viruses, scanning the message for finding viruses by the communications node.

11. A communications node comprising:
a communication interface receiving a message that comprises a virus scan tag which indicates whether or not the message was already scanned for electronic viruses;
a virus scan tag interpreter analysing the virus scan tag of the message to determine whether or not the message was already scanned for electronic viruses;
a processor that, responsive to a determination by the virus scan tag interpreter that the message was already scanned for electronic viruses, processes the message without scanning the message again for finding viruses.

12. The communications node claimed in claim 11, further comprises:
a message authenticator that acts to authenticate the message;
wherein the processor processes the message without scanning the message again for finding viruses not only responsive to i) the determination by the virus scan tag interpreter that the message was already scanned for viruses, but also responsive to ii) a successful authentication of the message by the message authenticator.

13. The communications node claimed in claim 12, wherein the message authenticator comprises a signature check module that acts to check an electronic signature of the message.

14. The communications node claimed in claim 12, wherein the message authenticator comprises a node Id check module that acts to check an identity of a sending node of the message.

15. The communications node claimed in claim 12, wherein the message authenticator comprises a decryptor module that acts to decrypt the message.

16. The communications node claimed in claim 12, wherein the message authenticator comprises a message integrity check module that acts to verify an integrity of the message.

17. The communications node claimed in claim 11, wherein the virus scan tag comprises a virus scan ok indication that indicates the message was already scanned for viruses, and a virus scan application identifier for identifying the application used for scanning the message, the virus scan tag interpreter further determining if the application used for scanning the message is trusted by the communications node;
wherein the processor acts to processes the message without scanning the message again for finding viruses as a result of the determination by the virus scan tag interpreter that i) the message was already scanned for viruses, and ii) the application used for the scanning the message is trusted by the communications node.

18. The communications node claimed in claim 11, wherein the virus scan tag comprises a virus scan ok indication that indicates the message was already scanned for viruses, and a virus definition file identifier for identifying the virus definition file used for scanning the message, the virus scan tag interpreter further determining if the virus definition file used for scanning the message is trusted by the communications node;
wherein the processor acts to processes the message without scanning the message again for finding viruses as a result of the determination by the virus scan tag interpreter that i) the message was already scanned for viruses, and ii) the virus definition file used for the scanning the message is trusted by the communications node.

19. The communications node claimed in claim 11, further comprising:
a virus scan module that acts to scan the message for finding viruses responsive to a determination by the virus scan tag interpreter that the message was not scanned for viruses.

20. A computer data signal message embodied in a transmission medium, the message comprising:
a virus scan tag segment which indicates whether or not the message was already scanned for electronic viruses; and
a security information segment for use by a receiving node of the message to authenticate the message;
wherein the receiving node uses the virus scan tag and the security information to determine whether or not the message is to be scanned for viruses. 21. The computer data signal message as claimed in claim 20, wherein:
the virus scan tag segment comprises:
a virus scan ok information segment indicating whether or not the message was already scanned for viruses;
a virus scan application identifier segment indicating a virus scan application used for scanning the message; and
a virus definition file identifier segment indicating a virus definition file used for scanning the message.
